(19) United States
(12) Patent Application Publication
(10) Pub. No.: US 2023/0308846 A1
(43) Pub. Date: Sep. 28, 2023

(54) SYSTEMS AND METHODS FOR MULTICAST COMMUNICATION FOR AR/VR SYSTEM

(71) Applicant: Meta Platforms Technologies, LLC, Menlo Park, CA (US)

(72) Inventors: Kanji Mavji KERAI, London (GB); Robert William HULVEY, Redondo Beach, CA (US); Abhishek Kumar AGRAWAL, Bellevue, WA (US)

(21) Appl. No.: 18/106,061

(22) Filed: Feb. 6, 2023

Related U.S. Application Data
(60) Provisional application No. 63/307,811, filed on Feb. 8, 2022.

(51) Int. Cl. H04W 4/80; H04W 4/02

(52) U.S. Cl. CPC H04W 4/80; H04W 4/023

(57) ABSTRACT

Systems and methods for multicast communication for an augmented reality (AR) / virtual reality (VR) system may include a first device that transmits a multicast message to a first peripheral device and a second peripheral device. The multicast message may include map data of a virtual environment. The first device may transmit, responsive to completing transmission of the multicast message, a poll message to the first peripheral device and the second peripheral device. The first device may receive, from the first peripheral device responsive to the poll message, first positioning data of the first peripheral device with respect to the map data. The first device may receive, from the second peripheral device responsive to the poll message, second positioning data of the second peripheral device with respect to the map data.

### CROSS-REFERENCE TO RELATED PATENT APPLICATIONS

This application claims the benefit of and priority to U.S. Provisional Application No. 63/307,811, filed Feb. 8, 2022, the contents of which are incorporated herein by reference in their entirety.

### FIELD OF DISCLOSURE

The present disclosure is generally related to communications, including but not limited systems and methods for multicast communication for an augmented reality (AR) / virtual reality (VR) system.

### BACKGROUND

Artificial reality such as a VR, AR, or a mixed reality (MR) provides immersive experience to a user. In one example, a user wearing a head wearable display (HWD) can turn the user’s head, and an image of a virtual object corresponding to a location of the HWD and a gaze direction of the user can be displayed on the HWD to allow the user to feel as if the user is moving within a space of artificial reality (e.g., a VR space, an AR space, or a MR space). An image of a virtual object may be generated by a console communicatively coupled to the HWD. In some embodiments, the console may have access to a network.

### SUMMARY

An augmented reality (AR) or virtual reality (VR) system may include a handheld or hand controller (HC) (also referred to herein as peripheral device(s)) and a head wearable display (HWD) (also referred to herein as a primary device). The HC may generate periodic inertial measurement unit (IMU) data indicating a sensed location/position/orientation/motion of the HC. The HC may transmit IMU data to the HWD for updating a user focus or focal region displayed on a screen or display of the HWD, thus enhancing user experience in the AR/VR system. The IMU data may be based on relative position measurements between the HC and HWD. The HC may generate the IMU data at a set or defined interval, such as every 2 ms. Relative position measurements generated by the HC may be prone to accumulated error over time. To compensate for accumulating error in the IMUdata, the HMD may periodically send map data to the HC. The HC may use the map data to reset an absolute position of the user in the map of the application. The map data may indicate or include mapping of HC locations to corresponding locations in a VR space for calibration.

Disclosed herein are systems and methods relating to transferring IMU and map data using various communication links between the HWD and HC(s). In some embodiments, the HWD and HC(s) may communicate via or through BLUETOOTH low energy (BLE) links between the respective devices. HWD and HCs may communicate through the link layer of the BLE technology using one Bluetooth device in the HMD and one Bluetooth device in each of the HC as shown in FIG. 1. The disclosed system may be optimized for co-existence between different antennas or physical communication devices on the HWD and HC(s) as well as stack implementations at the devices.

Each HC may generate relative position data, referred to as IMU data. The HCs may generate IMU data packets every 2 ms (e.g., 500 Hz). The IMU data may include movement data, such as six-degrees-of-freedom movement data. The movement data may include 18 bytes of data or higher, depending on the accuracy / granularity / level of detail of the data generated by the IMU sensor. The HC may communicate / wirelessly transfer the IMU data to the HWD. The IMU data may be isochronous in nature, in that every IMU data packet that is unsuccessfully transferred may be retransmitted a predetermined number of times and then flushed. An application in the HWD may display an image which shows the position of each HC. The full map data may be approximately 7 Mbytes. The HWD may communicate, send, transmit, share, or otherwise provide full map data to each HC at the start of an AR/VR application. The HWD may provide incremental (or partial) map data periodically to each HC. The incremental map data may be 5-10 MB, and may be generated every 5-10 minutes.

Some implementations of an AR/VR system may utilize wireless devices that implement a wireless controller to send IMU data from the HC(s) to the HWD (e.g., via BLUETOOTH), and uses a WI-FI connection to send the map data from HWD to the HCs. As such, there may be a total four wireless or BLUETOOTH devices for transferring IMU data (two in the HWD and one in each HC) and a total of three WI-FI devices for transferring the map data (one in the HWD and one in each HC). Such implementations may be expensive, both from a cost to deploy perspective and a form-factor perspective, and may suffer from interference due to the same radio channels of the 2.4 GHz ISM band used for all wireless connections. The interference may be partially managed by spatial separation of WI-FI and Bluetooth devices in the HWD.

According to the systems and methods described herein, to minimize the cost to deploy by reducing the number of wireless devices and have a better radio coexistence, the disclosed AR/VR system may communicate through BLE using multicast transmissions. Each of the HCs and the HWD may have a respective BLUETOOTH device, antenna, or stack. The HCs and HWD may communicate based on a multicast implementation in the link layer of BLUETOOTH stack.

In various embodiments, a first device (e.g., including or comprising a head wearable device (HWD)) may transmit a multicast message to a first peripheral device (such as a first handheld controller (HC)) and a second peripheral device (such as a second HC). The multicast message may include map data of a virtual environment. The first device may transmit, responsive to completing transmission of the multicast message, a poll message to the first peripheral device and the second peripheral device. The first device may receive, from the first peripheral device responsive to the poll message, first inertial measurement unit (IMU) data of the first peripheral device. The first device may receive, from the second peripheral device responsive to the poll, second IMU data of the second peripheral device.

The systems and methods described herein may provide for better coexistence between devices of an AR/VR system by reducing interference between different communication channels operating on or according to different protocols. The systems and methods described herein may provide for lower cost to deploy and better form factor deployments by reducing additional wireless devices needed to support different communication channels. Additional improvements and embodiments are described in greater detail below.

In one aspect, this disclosure is directed to a method. The method may include transmitting, by a first device, a multicast message to a first peripheral device and a second peripheral device. The multicast message may include map data of a virtual environment. The method may include transmitting, by the first device, responsive to completing transmission of the multicast message, a poll message to the first peripheral device and the second peripheral device. The method may include receiving, by the first device, from the first peripheral device responsive to the poll message, first positioning data of the first peripheral device with respect to the map data. The method may include receiving, by the first device, from the second peripheral device responsive to the poll message, second positioning data of the second peripheral device with respect to the map data.

In some embodiments, the method includes detecting, by the first device, launch of an application on the first device. The method may include causing, by the first device, each of the first device, the first peripheral device, and the second peripheral device to enter a multicast mode responsive to launching of the application. In some embodiments, the method may include detecting, by the first device, closing of the application on the first device. The method may include causing, by the first device, each of the first device, the first peripheral device, and the second peripheral device to exit the multicast mode responsive to closing of the application. In some embodiments, causing the first peripheral device and the second device to enter the multicast mode includes transmitting, by the first device, a first command to the first peripheral device, the first command indicating a start time for the first peripheral device to enter the multicast mode. Causing the first peripheral device and the second device to enter the multicast mode may include receiving, by the first device, an acknowledgement of the first command from the first peripheral device. Causing the first peripheral device and the second device to enter the multicast mode may include determining, by the first device, an offset for the second peripheral device. Causing the first peripheral device and the second device to enter the multicast mode may include transmitting, by the first device, a second command to the second peripheral device indicating a start time for the second peripheral device and the offset.

In some embodiments, the first positioning data includes first inertial measurement unit (IMU) data. Receiving the first IMU data may include receiving, by the first device, the first IMU data on a first channel from the first peripheral device, receiving, by the first device, the first IMU data on a second channel from the first peripheral device. In some embodiments, the method includes receiving, by the first device, a plurality of instances of an acknowledgement of the map data from the first peripheral device, the acknowledgement responsive to the multicast message. In some embodiments, the method includes receiving, by the first device, a first instance of the acknowledgement of the map data on a first channel from the first peripheral device. The method may include receiving, by the first device, the first positioning data on the first channel from the first peripheral device. The method may include receiving, by the first device, a second instance of the acknowledgement of the map data on a second channel from the first peripheral device. The method may include receiving, by the first device, the first positioning data on the second channel from the first peripheral device.

In some embodiments, the multicast message is a first multicast message comprising first map data of the virtual environment. The first multicast message may be sent at a first time instance. The method may include transmitting, by the first device at a second time instance which is a defined duration following the first time instance, a second multicast message to the first peripheral device and the second peripheral device. The second multicast message may include second map data of the virtual environment. In some embodiments, the second map data may include one or more updates to the first map data. In some embodiments, the multicast message and the poll are transmitted via a first Bluetooth low energy (BLE) device to a second BLE device of the first peripheral device and to a third BLE device of the second peripheral device. The first positioning data may be received by the first BLE device via the second BLE device from the first peripheral device. The second positioning data may be received by the first BLE device via the third BLE device from the second peripheral device. In some embodiments, the first device includes a head wearable device, the first peripheral device includes a first handheld controller communicably coupled to the head wearable device, and the second peripheral device includes a second handheld controller communicably coupled to the head wearable device.

In another aspect, this disclosure is directed to a first device. The first device may include a communication device. The communication device may be configured to transmit a multicast message to a first peripheral device and a second peripheral device. The multicast message may include map data of a virtual environment. The communication device may be configured to transmit, responsive to completing transmission of the multicast message, a poll message to the first peripheral device and the second peripheral device. The communication device may be configured to receive, from the first peripheral device responsive to the poll message, first positioning data of the first peripheral device with respect to the map data. The communication device may be configured to receive, from the second peripheral device responsive to the poll message, second positioning data of the second peripheral device with respect to the map data.

In some embodiments, the first device includes one or more processors configured to detect launch of an application on the first device, and cause each of the first device, the first peripheral device, and the second peripheral device to enter a multicast mode responsive to launching of the application. In some embodiments, the one or more processors are further configured to detect closing of the application on the first device, and cause each of the first device, the first peripheral device, and the second peripheral device to exit the multicast mode responsive to closing of the application. In some embodiments, to cause the first peripheral device and the second device to enter the multicast mode, the communication device is configured to transmit a first command to the first peripheral device, the first command indicating a start time for the first peripheral device to enter the multicast mode. The communication device may be configured to receive an acknowledgement of the first command from the first peripheral device. The communication device may be configured to transmit a second command to the second peripheral device indicating a start time for the second peripheral device and an offset determined for the second peripheral device.

In some embodiments, the first positioning data includes first inertial measurement unit (IMU) data. The communication device may be configured to receive the first IMU data on a first channel from the first peripheral device. The communication device may be configured to receive the first IMU data on a second channel from the first peripheral device. In some embodiments, the multicast message is a first multicast message comprising first map data of the virtual environment. The first multicast message may be sent at a first time instance. The communication device may be configured to transmit, at a second time instance which is a defined duration following the first time instance, a second multicast message to the first peripheral device and the second peripheral device, the multicast message comprising second map data of the virtual environment.

In some embodiments, the communication device includes a first Bluetooth low energy (BLE) device. The multicast message may be sent via the first BLE device to a second BLE device of the first peripheral device and to a third BLE device of the second peripheral device. The first positioning data may be received via the second BLE device from the first peripheral device. The second positioning data may be received via the third BLE device from the second peripheral device. In some embodiments, the first device includes a head wearable device, the first peripheral device includes a first handheld controller communicably coupled to the head wearable device, and the second peripheral device includes a second handheld controller communicably coupled to the head wearable device.

In yet another aspect, this disclosure is directed to a system. The system may include a first peripheral device, a second peripheral device, and a primary device communicably coupled to the first peripheral device and the second peripheral device. The primary device may be configured to transmit a multicast message to the first peripheral device and the second peripheral device. The multicast message may include map data of a virtual environment. The primary device may be configured to transmit, responsive to completing transmission of the multicast message, a poll message to the first peripheral device and the second peripheral device. The primary device may be configured to receive, from the first peripheral device responsive to the poll message, first positioning data of the first peripheral device with respect to the map data. The primary device may be configured to receive, from the second peripheral device responsive to the poll message, second positioning data of the second peripheral device with respect to the map data.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a diagram of a handheld controller, according to an example implementation of the present disclosure.

FIG. 4 is a block diagram of a computing environment according to an example implementation of the present disclosure.

FIG. 5 is a block diagram of a system for multicast communication for an augmented reality (AR) / virtual reality (VR) system, according to an example implementation of the present disclosure.

FIG. 6 is an example communication interval for switching between multicast mode and non-multicast mode, according to an example implementation of the present disclosure.

FIG. 7 is an example communication interval for switching between multicast mode and non-multicast mode, according to another example implementation of the present disclosure.

FIG. 8 is an example transmission sequence of the devices shown in the system of FIG. 5, according to an example implementation of the present disclosure.

FIG. 9 is an example transmission sequence of the devices shown in the system of FIG. 5, according to another example implementation of the present disclosure.

FIG. 10 is a flowchart of a method for multicast communication for an augmented reality (AR) / virtual reality (VR) system, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

An augmented reality (AR) or virtual reality (VR) system may include a handheld or hand controller (HC) (also referred to herein as peripheral device(s)) and a head wearable display (HWD) (also referred to herein as a primary device). The HC may generate periodic inertial measurement unit (IMU) data indicating a sensed location of the HC. The HC may transmit IMU data to the HWD for updating a user focus or focal region displayed on a screen or display of the HWD, thus enhancing user experience in the AR/VR system. The IMU data may be based on relative position measurements between the HC and HWD. The HC may generate the IMU data at a set or defined interval, such as every 2 ms. Relative position measurements generated by the HC may be prone to accumulated error over time. To compensate for accumulating error in the IMU data, the HMD may periodically send map data to the HC. The HC may use the map data to reset an absolute position of the user in the map of the application. The map data may indicate or include mapping of HC locations to corresponding locations in a VR space for calibration.

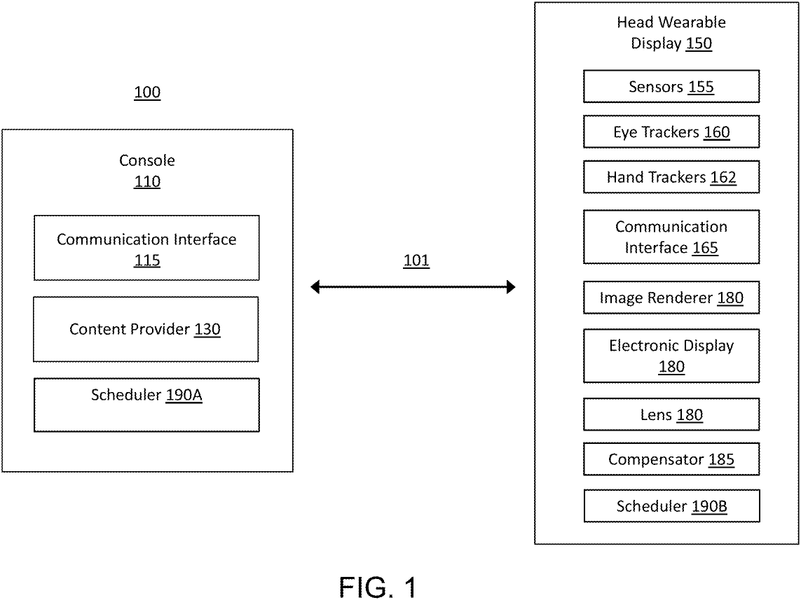

Disclosed herein are systems and methods relating to transferring IMU and map data using various communication links between the HWD and HC(s). In some embodiments, the HWD and HC(s) may communicate via or through BLUETOOTH low energy (BLE) links between the respective devices. HWD and HCs may communicate through the link layer of the BLE technology using one Bluetooth device in the HMD and one Bluetooth device in each of the HC as shown in FIG. 1. The disclosed system may be optimized for co-existence between different antennas or physical communication devices on the HWD and HC(s) as well as stack implementations at the devices.

Each HC may generate relative position data, referred to as IMU data. The HCs may generate IMU data packets every 2 ms (e.g., 500 Hz). Each IMU data packet may be approximately 50 bytes which can be wirelessly transferred to the HWD. The IMU data may be isochronous in nature, in that every IMU data packet that is unsuccessfully transferred may be retransmitted a predetermined number of times and then flushed. An application in the HWD may display an image which shows the position of each HC. The full map data may be approximately 7 Mbytes. The HWD may communicate, send, transmit, share, or otherwise provide full map data to each HC at the start of an AR/VR application. The HWD may provide incremental (or partial) map data periodically to each HC. The incremental map data may be 5-10 MB, and may generated every 5-10 minutes.

Some implementations of an AR/VR system may utilize wireless devices that implement a wireless controller to send IMU data from the HC(s) to the HWD (e.g., via BLUETOOTH), and uses a WI-FI connection to send the map data from HWD to the HCs. As such, there may be a total four wireless or BLUETOOTH devices for transferring IMU data (two in the HWD and one in each HC) and a total of three WI-FI devices for transferring the map data (one in the HWD and one in each HC). Such implementations may be expensive, both from a cost to deploy perspective and a form-factor perspective, and may suffer from interference due to the same radio channels of the 2.4 GHz ISM band used for all wireless connections. The interference may be partially managed by spatial separation of WI-FI and Bluetooth devices in the HWD.

According to the systems and methods described herein, to minimize the cost to deploy by reducing the number of wireless devices and have a better radio coexistence, the disclosed AR/VR system may communicate through BLE using multicast transmissions. Each of the HCs and the HWD may have a respective BLUETOOTH device, antenna, or stack. The HCs and HWD may communicate based on a multicast implementation in the link layer of BLUETOOTH stack.

In various embodiments, a first device (e.g., including or comprising a head wearable device (HWD)) may transmit a multicast message to a first peripheral device (such as a first handheld controller (HC)) and a second peripheral device (such as a second HC). The multicast message may include map data of a virtual environment. The first device may transmit, responsive to completing transmission of the multicast message, a poll message to the first peripheral device and the second peripheral device. The first device may receive, from the first peripheral device responsive to the poll message, first inertial measurement unit (IMU) data of the first peripheral device. The first device may receive, from the second peripheral device responsive to the poll message, second IMU data of the second peripheral device.

The systems and methods described herein may provide for better coexistence between devices of an AR/VR system by reducing interference between different communication channels operating on or according to different protocols. The systems and methods described herein may provide for lower cost to deploy and better form factor deployments by reducing additional wireless devices needed to support different communication channels. Additional improvements and embodiments are described in greater detail below.

FIG. 1 is a block diagram of an example artificial reality system environment 100 in which a console 110 operates. FIG. 1 provides an example environment in which devices may communicate traffic streams with different latency sensitivities/requirements. In some embodiments, the artificial reality system environment 100 includes a HWD 150 worn by a user, and a console 110 providing content of artificial reality to the HWD 150. A head wearable display (HWD) may be referred to as, include, or be part of a head mounted display (HMD), head mounted device (HMD), head wearable device (HWD), head worn display (HWD) or head worn device (HWD). In one aspect, the HWD 150 may include various sensors to detect a location, an orientation, and/or a gaze direction of the user wearing the HWD 150, and provide the detected location, orientation and/or gaze direction to the console 110 through a wired or wireless connection. The HWD 150 may also identify objects (e.g., body, hand face).

The console 110 may determine a view within the space of the artificial reality corresponding to the detected location, orientation and/or the gaze direction, and generate an image depicting the determined view. The console 110 may also receive one or more user inputs (e.g., via a controller, such as a handheld controller) and modify the image according to the user inputs. The console 110 may provide the image to the HWD 150 for rendering. The image of the space of the artificial reality corresponding to the user’s view can be presented to the user. In some embodiments, the artificial reality system environment 100 includes more, fewer, or different components than shown in FIG. 1. In some embodiments, functionality of one or more components of the artificial reality system environment 100 can be distributed among the components in a different manner than is described here. For example, some of the functionality of the console 110 may be performed by the HWD 150, and/or some of the functionality of the HWD 150 may be performed by the console 110.

In some embodiments, the HWD 150 is an electronic component that can be worn by a user and can present or provide an artificial reality experience to the user. The HWD 150 may render one or more images, video, audio, or some combination thereof to provide the artificial reality experience to the user. In some embodiments, audio is presented via an external device (e.g., speakers and/or headphones) that receives audio information from the HWD 150, the console 110, or both, and presents audio based on the audio information. In some embodiments, the HWD 150 includes sensors 155, eye trackers 160, a communication interface 165, an image renderer 170, an electronic display 175, a lens 180, and a compensator 185. These components may operate together to detect a location of the HWD 150 and/or a gaze direction of the user wearing the HWD 150, and render an image of a view within the artificial reality corresponding to the detected location of the HWD 150 and/or the gaze direction of the user. In other embodiments, the HWD 150 includes more, fewer, or different components than shown in FIG. 1.

In some embodiments, the sensors 155 include electronic components or a combination of electronic components and software components that detect a location and/or an orientation of the HWD 150. Examples of sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and/or the rotational movement, and determine an orientation and location of the HWD 150. In one aspect, the sensors 155 can detect the translational movement and/or the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the eye trackers 160 include electronic components or a combination of electronic components and software components that determine a gaze direction of the user of the HWD 150. In some embodiments, the HWD 150, the console 110 or a combination may incorporate the gaze direction of the user of the HWD 150 to generate image data for artificial reality. In some embodiments, the eye trackers 160 include two eye trackers, where each eye tracker 160 captures an image of a corresponding eye and determines a gaze direction of the eye. In one example, the eye tracker 160 determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker 160 may shine or project a predetermined reference or structured pattern on a portion of the eye, and capture an image of the eye to analyze the pattern projected on the portion of the eye to determine a relative gaze direction of the eye with respect to the HWD 150. In some embodiments, the eye trackers 160 incorporate the orientation of the HWD 150 and the relative gaze direction with respect to the HWD 150 to determine a gaze direction of the user. Assuming for an example that the HWD 150 is oriented at a direction 30 degrees from a reference direction, and the relative gaze direction of the HWD 150 is -10 degrees (or 350 degrees) with respect to the HWD 150, the eye trackers 160 may determine that the gaze direction of the user is 20 degrees from the reference direction. In some embodiments, a user of the HWD 150 can configure the HWD 150 (e.g., via user settings) to enable or disable the eye trackers 160. In some embodiments, a user of the HWD 150 is prompted to enable or disable the eye trackers 160.

In some embodiments, the hand tracker 162 includes an electronic component or a combination of an electronic component and a software component that tracks a hand of the user. In some embodiments, the hand tracker 162 includes or is coupled to an imaging sensor (e.g., camera) and an image processor that can detect a shape, a location and/or an orientation of the hand. The hand tracker 162 may generate hand tracking measurements indicating the detected shape, location and/or orientation of the hand.

In some embodiments, the communication interface 165 includes an electronic component or a combination of an electronic component and a software component that communicates with the console 110. The communication interface 165 may communicate with a communication interface 115 of the console 110 through a communication link. The communication link may be a wireless link, a wired link, or both. Examples of the wireless link can include a cellular communication link, a near field communication link, Wi-Fi, Bluetooth, or any communication wireless communication link. Examples of the wired link can include a USB, Ethernet, Firewire, HDMI, or any wired communication link. In embodiments in which the console 110 and the head wearable display 150 are implemented on a single system, the communication interface 165 may communicate with the console 110 through a bus connection or a conductive trace. Through the communication link, the communication interface 165 may transmit to the console 110 sensor measurements indicating the determined location of the HWD 150, orientation of the HWD 150, the determined gaze direction of the user, and/or hand tracking measurements. Moreover, through the communication link, the communication interface 165 may receive from the console 110 sensor measurements indicating or corresponding to an image to be rendered.

Using the communication interface, the console 110 (or HWD 150) may coordinate operations on link 101 to reduce collisions or interferences. For example, the console 110 may coordinate communication between the console 110 and the HWD 150. In some implementations, the console 110 may transmit a beacon frame periodically to announce/advertise a presence of a wireless link between the console 110 and the HWD 150 (or between two HWDs). In an implementation, the HWD 150 may monitor for or receive the beacon frame from the console 110, and can schedule communication with the HWD 150 (e.g., using the information in the beacon frame, such as an offset value) to avoid collision or interference with communication between the console 110 and/or HWD 150 and other devices.

The console 110 and HWD 150 may communicate using link 101 (e.g., intralink). Data (e.g., a traffic stream) may flow in a direction on link 101. For example, the console 110 may communicate using a downlink (DL) communication to the HWD 150 and the HWD 150 may communicate using an uplink (UL) communication to the console 110.

In some embodiments, the image renderer 170 includes an electronic component or a combination of an electronic component and a software component that generates one or more images for display, for example, according to a change in view of the space of the artificial reality. In some embodiments, the image renderer 170 is implemented as a processor (or a graphical processing unit (GPU)) that executes instructions to perform various functions described herein. The image renderer 170 may receive, through the communication interface 165, data describing an image to be rendered, and render the image through the electronic display 175. In some embodiments, the data from the console 110 may be encoded, and the image renderer 170 may decode the data to generate and render the image. In one aspect, the image renderer 170 receives the encoded image from the console 110, and decodes the encoded image, such that a communication bandwidth between the console 110 and the HWD 150 can be reduced.

In some embodiments, the image renderer 170 receives, from the console, 110 additional data including object information indicating virtual objects in the artificial reality space and depth information indicating depth (or distances from the HWD 150) of the virtual objects. Accordingly, the image renderer 170 may receive from the console 110 object information and/or depth information. The image renderer 170 may also receive updated sensor measurements from the sensors 155. The process of detecting, by the HWD 150, the location and the orientation of the HWD 150 and/or the gaze direction of the user wearing the HWD 150, and generating and transmitting, by the console 110, a high resolution image (e.g., 1920 by 1080 pixels, or 2048 by 1152 pixels) corresponding to the detected location and the gaze direction to the HWD 150 may be computationally exhaustive and may not be performed within a frame time (e.g., less than 11 ms or 8 ms).

In some implementations, the image renderer 170 may perform shading, reprojection, and/or blending to update the image of the artificial reality to correspond to the updated location and/or orientation of the HWD 150. Assuming that a user rotated their head after the initial sensor measurements, rather than recreating the entire image responsive to the updated sensor measurements, the image renderer 170 may generate a small portion (e.g., 10 %) of an image corresponding to an updated view within the artificial reality according to the updated sensor measurements, and append the portion to the image in the image data from the console 110 through reprojection. The image renderer 170 may perform shading and/or blending on the appended edges. Hence, without recreating the image of the artificial reality according to the updated sensor measurements, the image renderer 170 can generate the image of the artificial reality.

In other implementations, the image renderer 170 generates one or more images through a shading process and a reprojection process when an image from the console 110 is not received within the frame time. For example, the shading process and the reprojection process may be performed adaptively, according to a change in view of the space of the artificial reality.

In some embodiments, the electronic display 175 is an electronic component that displays an image. The electronic display 175 may, for example, be a liquid crystal display or an organic light emitting diode display. The electronic display 175 may be a transparent display that allows the user to see through. In some embodiments, when the HWD 150 is worn by a user, the electronic display 175 is located proximate (e.g., less than 3 inches) to the user’s eyes. In one aspect, the electronic display 175 emits or projects light towards the user’s eyes according to image generated by the image renderer 170.

In some embodiments, the lens 180 is a mechanical component that alters received light from the electronic display 175. The lens 180 may magnify the light from the electronic display 175, and correct for optical error associated with the light. The lens 180 may be a Fresnel lens, a convex lens, a concave lens, a filter, or any suitable optical component that alters the light from the electronic display 175. Through the lens 180, light from the electronic display 175 can reach the pupils, such that the user can see the image displayed by the electronic display 175, despite the close proximity of the electronic display 175 to the eyes.

In some embodiments, the compensator 185 includes an electronic component or a combination of an electronic component and a software component that performs compensation to compensate for any distortions or aberrations. In one aspect, the lens 180 introduces optical aberrations such as a chromatic aberration, a pin-cushion distortion, barrel distortion, etc. The compensator 185 may determine a compensation (e.g., predistortion) to apply to the image to be rendered from the image renderer 170 to compensate for the distortions caused by the lens 180, and apply the determined compensation to the image from the image renderer 170. The compensator 185 may provide the predistorted image to the electronic display 175.

In some embodiments, the console 110 is an electronic component or a combination of an electronic component and a software component that provides content to be rendered to the HWD 150. In one aspect, the console 110 includes a communication interface 115 and a content provider 130. These components may operate together to determine a view (e.g., a field of view (FOV) of the user) of the artificial reality corresponding to the location of the HWD 150 and/or the gaze direction of the user of the HWD 150, and can generate an image of the artificial reality corresponding to the determined view. In other embodiments, the console 110 includes more, fewer, or different components than shown in FIG. 1. In some embodiments, the console 110 is integrated as part of the HWD 150. In some embodiments, the communication interface 115 is an electronic component or a combination of an electronic component and a software component that communicates with the HWD 150. The communication interface 115 may be a counterpart component to the communication interface 165 to communicate with a communication interface 115 of the console 110 through a communication link (e.g., USB cable, a wireless link). Through the communication link, the communication interface 115 may receive from the HWD 150 sensor measurements indicating the determined location and/or orientation of the HWD 150, the determined gaze direction of the user, and/or hand tracking measurements. Moreover, through the communication link, the communication interface 115 may transmit to the HWD 150 data describing an image to be rendered.

The content provider 130 can include or correspond to a component that generates content to be rendered according to the location and/or orientation of the HWD 150, the gaze direction of the user and/or hand tracking measurements. In one aspect, the content provider 130 determines a view of the artificial reality according to the location and orientation of the HWD 150 and/or the gaze direction of the user of the HWD 150. For example, the content provider 130 maps the location of the HWD 150 in a physical space to a location within an artificial reality space, and determines a view of the artificial reality space along a direction corresponding to an orientation of the HWD 150 and/or the gaze direction of the user from the mapped location in the artificial reality space.

The content provider 130 may generate image data describing an image of the determined view of the artificial reality space, and transmit the image data to the HWD 150 through the communication interface 115. The content provider may also generate a hand model (or other virtual object) corresponding to a hand of the user according to the hand tracking measurement, and generate hand model data indicating a shape, a location, and an orientation of the hand model in the artificial reality space.

In some embodiments, the content provider 130 generates metadata including motion vector information, depth information, edge information, object information, etc., associated with the image, and transmits the metadata with the image data to the HWD 150 through the communication interface 115. The content provider 130 may encode and/or encode the data describing the image, and can transmit the encoded and/or encoded data to the HWD 150. In some embodiments, the content provider 130 generates and provides the image to the HWD 150 periodically (e.g., every one second).

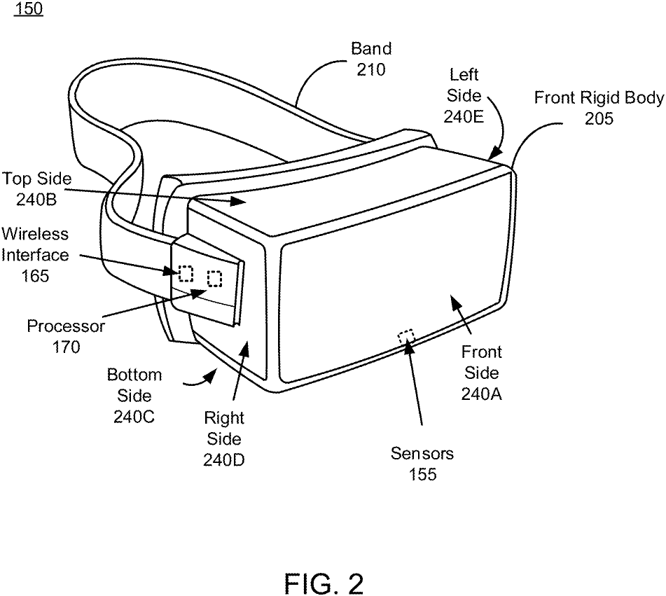

FIG. 2 is a diagram of a HWD 150, in accordance with an example embodiment. In some embodiments, the HWD 150 includes a front rigid body 205 and a band 210. The front rigid body 205 includes the electronic display 175 (not shown in FIG. 2), the lens 180 (not shown in FIG. 2), the sensors 155, the eye trackers 160A, 160B, the communication interface 165, and the image renderer 170. In the embodiment shown by FIG. 2, the sensors 155 are located within the front rigid body 205, and may not visible to the user. In other embodiments, the HWD 150 has a different configuration than shown in FIG. 2. For example, the image renderer 170, the eye trackers 160A, 160B, and/or the sensors 155 may be in different locations than shown in FIG. 2.

In some embodiments, a user of an artificial reality system, in addition to wearing a HWD 150, may also use or otherwise operate one or more additional devices located at different positions on the user’s body. For example, in some embodiments, the user may use a controller device to perform various actions within the artificial reality environment. In some embodiments, the controller device may include a handheld controller held in the user’s hand.

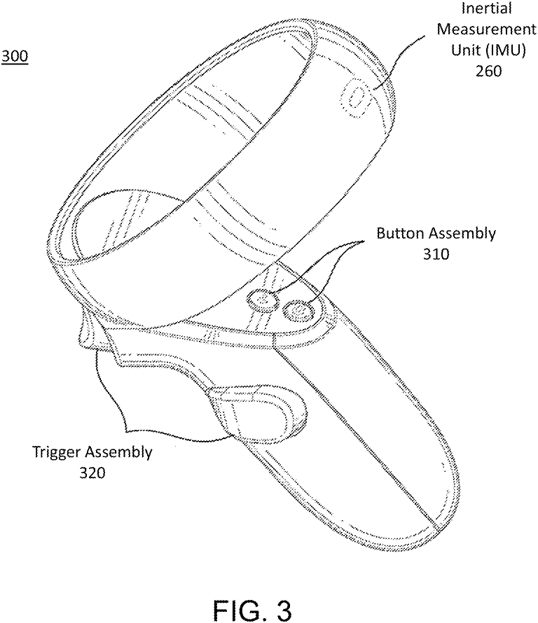

FIG. 3 is a side view of a handheld controller 300, in accordance with one or more embodiments. The handheld controller 300 may be an embodiment of a controller device configured to be held in a hand of the user for providing various inputs to the artificial reality environment. The handheld controller 300 may include one or more interface elements configured to receive input from a user of the handheld controller 300, such as a button assembly 310, a trigger assembly 320, or a combination thereof. The user may use the interface elements to perform action requests and receive responses from a console of the system (such as the console 110 of FIG. 1) and/or the HWD 150 of the system. An action request may be or include a request to perform a particular action. For example, an action request may be an instruction to start or end capture of image or video data, or an instruction to perform a particular action within an application, or the like. The handheld controller 300 may include a position sensor corresponding to an IMU 360. The IMU 360 of the handheld controller 300 may be or include a sensor designed or configured to measure acceleration, movement, inertia, or other data indicative of motion of the handheld controller 300. In other embodiments, the handheld controller 300 may include additional components than those listed. For example, the handheld controller 300 may have additional interface elements, multiple IMUs 360, and/or other types of sensors. In the embodiment of FIG. 3, the handheld controller 300 is configured to operate with one hand of the user. In some embodiments, a second handheld controller with mirror symmetry in relation to the handheld controller 300 may be configured to operate with the other hand of the user.

The button assembly 310 may include one or more buttons that each receive input when at least partially depressed. Each button of the button assembly 310 may translate along one or more axes. In some embodiments, a button translates along a single axis. Translation of a button along the one or more axes may correspond to various inputs. In some embodiments, a button may receive an input when the button is depressed by a threshold distance corresponding to a threshold translation of the button along an axis. In some embodiments, a button of the button assembly 310 may include a capacitive sensor configured to or capable of detecting a proximity of the user’s skin to the button. The button assembly 310 may include a multitude of buttons each configured to receive one or more inputs. In one embodiment, the button assembly comprises one or more buttons configured as a directional pad (D-pad) with each button of the D-pad corresponding to a directional input.

The trigger assembly 320 may include one or more triggers that each receive input when depressed. Each trigger of the trigger assembly 320 may be fixed at a point providing rotational movement of the trigger about the fixed point. In some embodiments, a trigger may receive an input when the trigger is rotated more than some threshold degree. In some embodiments, a trigger may detect a range of angular rotation of the trigger. In some embodiments, each trigger may be a capacitive sensor capable of detecting a proximity of the user’s skin to the trigger.

The IMU 360 may be configured to generate one or more measurement signals in response to motion of the HMD 150. The IMU 360 may be located on a structure of the handheld controller 300. The IMU 360 may include various accelerometers and/or gyroscopes that measure an acceleration and/or angular rate, based on movement of the handheld controller 300. The IMU 360 may be located on a structure of the handheld controller 300 to allow for the one or more accelerometers and one or more gyroscopes of the IMU to measure an acceleration and angular rate caused by movement of the handheld controller 300. In some embodiments, the IMU 360 may include a controller configured to determine positional information based upon measurements generated by the IMU. In some embodiments, the IMU 360 may be configured to transmit sensor information (e.g., IMU measurements) to a separate device or console (such as the HMD 150, the console 110, etc.) which determines the positional information of the handheld controller 300 based on the received information.

The handheld controller 300, the console 110, and the HWD 150 may be configured to communicate via various links, similar to link 101. As described in greater detail below, the handheld controller 300, console 110, and HWD 150 may be configured to exchange, transmit, and/or receive data between the devices via the links 101. Such data may include, for example, action inputs or commands, IMU data, map data, etc.

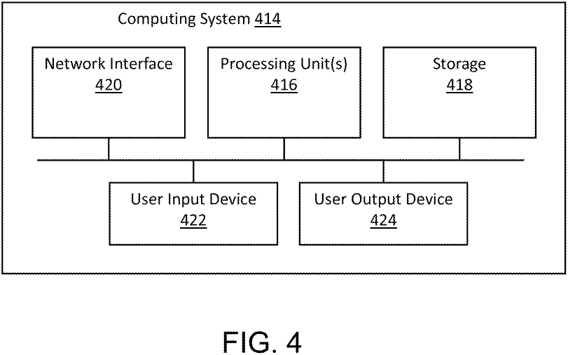

Various operations described herein can be implemented on computer systems. FIG. 4 shows a block diagram of a representative computing system 414 usable to implement the present disclosure. In some embodiments, the console 110, the HWD 150 or both of FIG. 1 and/or the handheld controller 300 of FIG. 3 are implemented by the computing system 414. Computing system 414 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 414 can be implemented to provide VR, AR, MR experience. In some embodiments, the computing system 414 can include conventional computer components such as processors 416, storage device 418, network interface 420, user input device 422, and user output device 424.

Network interface 420 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 420 may include a transceiver to allow the computing system 414 to transmit and receive data from a remote device (e.g., an AP, a STA) using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 416. Similarly, a receiver may be configured to receive frames, slots or symbols and the processor unit 416 may be configured to process the frames. For example, the processor unit 416 can be configured to determine a type of frame and to process the frame and/or fields of the frame accordingly.

User input device 422 can include any device (or devices) via which a user can provide signals to computing system 414; computing system 414 can interpret the signals as indicative of particular user requests or information. User input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 424 can include any device via which computing system 414 can provide information to a user. For example, user output device 424 can include a display to display images generated by or delivered to computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

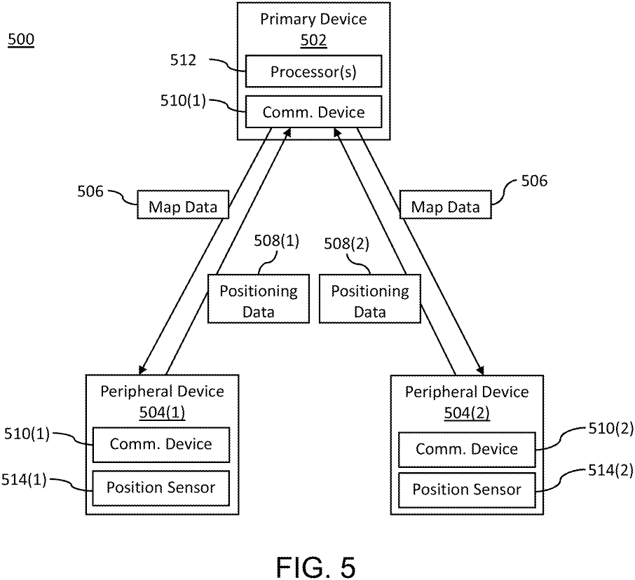

Referring now to FIG. 5, depicted is a block diagram of a system 500 for multicast communication for an augmented reality (AR) / virtual reality (VR) system, according to an example implementation of the present disclosure. The system 500 is shown to include a primary device 502 and a plurality of peripheral devices 504(1), 504(2) (referred to generally as peripheral devices 504 or peripheral device 504). The primary device 502 may be or include a head wearable device (HWD), such as or similar to the HWD 150 described above, a console or controller, such as the console 110 described above, or the like. The peripheral devices 504 may be or include a hand or handheld controller, such as the handheld controller 300 described above. While shown as two peripheral devices 504(1), 504(2), it is noted that the system 500 may include any number of peripheral devices 504. As described in greater detail below, the primary device 502 may be configured to transmit a multicast message to peripheral devices 504. The multicast message may include map data 506 of a virtual environment. The primary device 502 may transmit a poll message to the peripheral devices 504 responsive to transmitting the multicast message. The primary device 502 may receive, from the first peripheral device 504(1), first positioning data 508(1) of the first peripheral device 504(1) with respect to the map data 506. The primary device 502 may receive, from the second peripheral device 504(2), second positioning data 508(2) of the second peripheral device 504(2) with respect to the map data 506.

The primary device 502 and peripheral devices 504 are shown to include communication devices 510. The communication devices 510 may be or include any device, component, antenna, structure, or hardware designed or configured to wirelessly communicate various information between two or more devices. For example, the communication devices 510 may be or include wireless devices configured to operate over short distances within a personal area network (PAN). The communication devices 510 may be configured to transmit wireless messages in a band or bandwidth ranging between 2.400 GHz to 2.48 GHz. As one example, the communication devices 510 may be or include BLUETOOTH low energy (BLE) devices. The primary devices 502 and peripheral devices 504 may be configured to establish various connections between the communication devices 510 responsive to performing a pairing procedure using the communication devices 510. For example, the primary device 502 may be configured to discover and connect to each of the peripheral devices 504 according to a discovery and connectivity procedure. The primary device 502 may be configured to operate as a central role or device, and the peripheral devices 504 may be configured to operate as secondary or peripheral roles or devices. The primary device 502 and peripheral devices 504 may be configured to establish or maintain respective asynchronous connection-less (ACL) connections between the respective devices. The ACL connections may have a connection interval of approximately 50 ms, according to an example implementation of the present disclosure.

The primary device 502 is shown to include one or more processor(s) 512. The processor(s) 512 may be or include any device, component, or hardware designed or configured to execute various functions of the primary device 502. For example, the processor(s) 512 may be configured to control the communication device 510(1) to enter and exit the multicast mode as described herein, execute application(s) of the primary device 502, generate and transmit map data 506 corresponding to the application(s) to the peripheral devices 504, and/or use positioning data 508 from the peripheral devices 504 to update displays rendered to users of the primary device 502. The processor(s) 512 may be configured to generate the map data 506 based on or according to the application executing on the primary device 502. The map data 506 may thus include a mapping of a virtual environment generated by the application executing on the primary device 502. The virtual environment may correspond to a local, physical environment of the primary device 502. For example, the virtual environment may include representations of landmarks of the physical environment of the primary device 502. As such, the primary device 502 may be configured to generate the map data 506 based on or according to measurements or other data indicative of a pose of the user (e.g., of the primary device 502) with respect to the physical environment. The peripheral devices 504 may be configured to use the map data 506 to update or calibrate a relative position of the peripheral devices 504 with respect to the map data 506.

The peripheral devices 504 are shown to include respective position sensors 514. The position sensors 514 may be or include any component, device, hardware, or sensor designed or configured to measure, sense, quantify, or otherwise determine the positioning data 508 for the respective device 504 on which the position sensor 514 is provided. The position sensors 514 may include various accelerometers and/or gyroscopes that measure an acceleration and/or angular rate, based on movement of the respective peripheral devices 504. The position sensors 514 may be mounted, attached, affixed, or otherwise provided anywhere on a body of the peripheral devices 504 to measure a position or change in position (e.g., displacement, orientation, motion, acceleration) of the respective device 504. The position sensors 514 may be the IMU(s) 360 described above with reference to FIG. 3. The peripheral devices 504 may be configured to transmit, send, or otherwise provide the position data 508 to the primary device 502 at various intervals.

When a user of the primary device 502 operates the primary device 502 to start, launch, deploy, or otherwise access an application on the primary device 502, the primary device 502 may be configured to cause each of the primary device 502 and peripheral devices 504 to enter a multicast mode. As described in greater detail below, at the start of the multicast mode, the primary device 502 may be configured to transmit, send, or otherwise provide the map data 506 to the peripheral devices 504. Upon or after transmitting the map data 506 to the peripheral devices 504, the primary device 502 may be configured to send, transmit, or otherwise provide poll packets to the peripheral devices 504. The peripheral devices 504 may be configured to respond to the poll packets with positioning data 508 of the respective devices 504 to the primary device 502. The primary device 502 may be configured to periodically send incremental or portions of the map data 506 to the peripheral devices 504 so that the peripheral devices 504 can calibrate the positional data to the updated map data 506. The primary device 502 and peripheral devices 504 may be configured to exit the multicast mode responsive to the user ending or terminating the application on the primary device 502.

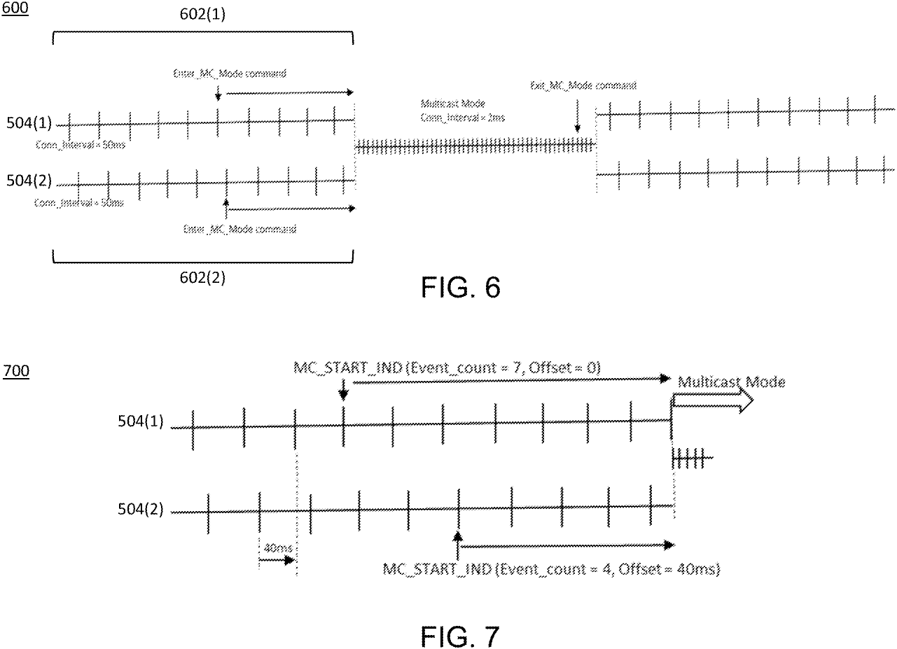

Referring generally to FIG. 6 and FIG. 7, depicted are example communication intervals 600, 700 for switching between multicast mode and non-multicast mode, according to example implementations of the present disclosure. As noted above, the primary device 502 may be configured to cause each of the devices 502, 504 to enter and exit a multicast mode based on or according to a user launching an application on the primary device 502. The primary device 502 and each of the peripheral devices 504 may be configured to establish respective ACL connections 602(1), 602(2). The primary device 502 and peripheral devices 502 may be configured to establish the ACL connections 602(1), 602(2) responsive to the devices 502, 504 being turned on and following discovery and pairing. The primary device 502 may be configured to detect or identify launch of an application (such as an AR/VR application) by a user of the primary device 502. The primary device 502 may be configured to send a prompt, signal, or command to the first and second peripheral devices 504(1), 504(2), to cause each of the devices 502, 504 to switch to or otherwise enter the multicast mode.

When the primary device 502 identifies launch of the application, the primary device 502 may be configured to provide, send, communicate or otherwise transmit a command to the first peripheral device 504(1) indicating a start time for the first peripheral device 504(1) to enter the multicast mode. The primary device 502 may be configured to determine the start time based on the connection interval of the ACL connection 602(1) and a predetermined minimum number of intervals. The predetermined number of intervals may correspond to a minimum duration for the primary device 502 to cause both of the peripheral devices 504 to enter the multicast mode. The predetermined minimum number of intervals may be or include, for example, four intervals, five intervals, six intervals, seven intervals, etc. In the example illustrated in FIG. 6, the number of intervals may be five intervals. In the example illustrated in FIG. 7, the number of intervals may be seven intervals. The primary device 502 may be configured to transmit the command to indicate that the peripheral device 504 is to switch to or otherwise enter to the multicast mode after the number of intervals. The peripheral device 504, upon receiving the command, may be configured to transmit an acknowledgement back to the primary device 502 and count a number of intervals from the first instance in which the command is received. Once the count is equal to the number of intervals identified in the command, the first peripheral device 504 may be configured to switch to the multicast mode. Table 1 below shows an example format for the command sent by the primary device 502 to the first (and second) peripheral devices 504(1), 504(2).

TABLE 1

Format for Command to Enter Multicast Mode
CtrlData

| | | | | | | | |
|---|---|---|---|---|---|---|---|
| MC_AA | Peripheral _No | No_of_Tx | MC_ Interval | MC_Sub Interval | Timeout | Event_ Count | Offset |

As illustrated in Table 1, the command may include a number of fields, including a multicast access address (MC_AA) [four octets], a peripheral number for the peripheral device 504 [one octet], a number of transmissions by each peripheral device 504 [one octet], a multicast interval (in microseconds) [three octets], a multicast subinterval (in microseconds) [two octets], a timeout (in milliseconds) [two octets], an event count (e.g., a number of connection intervals after which the peripheral device 504 is to switch to the multicast mode) [one octet], and an offset (e.g., a time in microseconds to start multicast mode) [two octets]. The primary device 502 may be configured to populate the fields of the command for a particular peripheral device 504, to generate the command that causes the peripheral device 504 to enter the multicast mode.

As shown in FIG. 7, the primary device 502 may be configured to determine or compute an offset or offset value for the second peripheral device 504(2). The primary device 502 may be configured to determine the offset based on a difference between a start of an interval for the first ACL 602(1) and a start of a nearest interval for the second ACL 602(2). As illustrated in FIG. 7, the offset may be 40 ms, though it should be noted that any offset value may be determined by the primary device 502 (e.g., between 0 ms and the full duration of the connection interval, or 50 ms in this example).

The primary device 502 may be configured to generate a second command for the second peripheral device 504(2). The primary device 502 may be configured to generate the second command to include, among other values, data indicative of the start time for the second peripheral device 504(2) to enter the multicast mode. The primary device 502 may be configured to determine the start time for the second peripheral device 504(2) to enter the multicast mode, so that both of the first and second peripheral devices 504(1), 504(2) can enter the multicast mode at the same time as the primary device 502. The primary device 502 may be configured to generate the second command in a manner similar to the first command described above. As such, the second command may have a format similar to the format described above with reference to Table 1. At the start time, each of the primary device 502 and peripheral devices 504 may be configured to switch to the multicast mode.

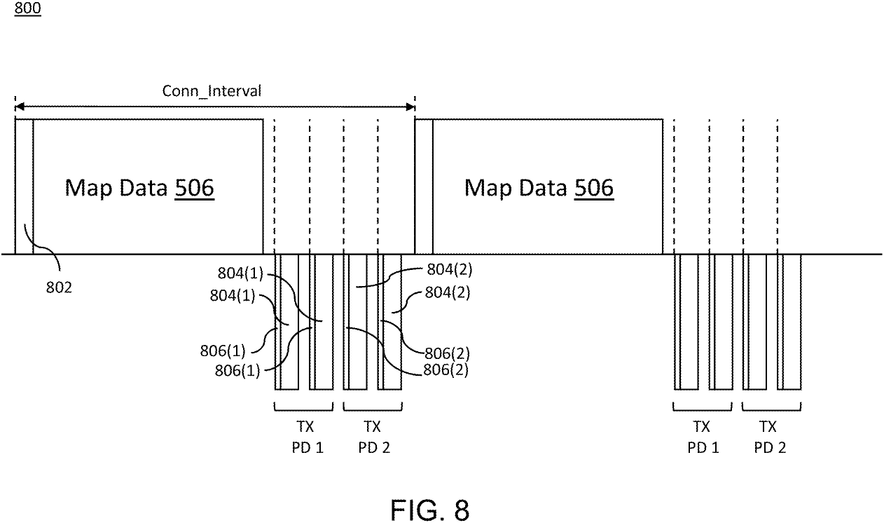

Referring now to FIG. 8, depicted is a transmission sequence 800 of the devices 502, 504 shown in the system 500, according to an example implementation of the present disclosure. The transmission sequence 800 may be or include the transmissions performed by the devices 502, 504 in the multicast mode. In the Multicast mode, the primary device 502 may be configured to set the connection interval to 2 ms (e.g., by configuring the command accordingly with a value in the corresponding field for the connection interval). The first and second peripheral devices 504(1), 504(2) may be configured to perform a common frequency hopping sequence such that, when the primary device 502 transmits a packet, the peripheral devices 504 may receive the packet at the same time. The peripheral devices 504 may be configured to respond with acknowledgements and positioning data as described in greater detail below.

Referring to FIG. 5 and FIG. 8, the primary device 502 may be configured to transmit a first data packet or multicast message to both peripheral devices 504. The first multicast message may include a header 802 and map data 506 for the virtual or augmented reality environment. As noted above, the primary device 502 (e.g., the processor(s) 512 of the primary device 502) may be configured to generate the map data 506 based on, according to, or using data from the application executing on the primary device 502. The primary device 502 may be configured to generate the map data 506 responsive to the application being deployed or executing on the primary device 502. The primary device 502 may be configured to communicate, send, provide, or otherwise transmit the map data 506 to the peripheral devices 504 via a multicast message. The primary device 502 may be configured to transmit the multicast message using the communication device 510(1) (a BLE device, for instance) of the primary device 502.

The peripheral devices 504 may be configured to detect, identify, register, or otherwise receive the map data 506 from the primary device 502. The peripheral devices 504 may be configured to establish, set, define, or otherwise configure an absolute position of the peripheral devices 504 with respect to the map data 506 in the virtual or augmented reality environment based on the map data 506. For instance, the peripheral devices 504 may be configured to use the map data 506 for providing the positioning data 508 to the primary device 502. As such, as the peripheral devices 504 move about the physical environment or space, the peripheral devices 504 may be configured to generate positional data 508 reflecting or otherwise identifying a change in the position of the peripheral device 504 with respect to the absolute position (or previous position, which itself is a delta from the absolute position).

Once the primary device 502 transmits the map data 506, the primary device 502 may be configured to transmit, send, or otherwise provide a poll message to the peripheral devices 504. The poll message may poll the peripheral devices 504 for positioning data 508. In some embodiments, the primary device 502 may be configured to transmit the poll message via a multicast message to each of the peripheral devices 504. In some embodiments, the primary device 502 may be configured to transmit the poll message to each of the peripheral devices 504 via separate messages and/or on separate channels.

Referring specifically to FIG. 8, the peripheral devices 504 may be configured to generate a response to poll message / the map data 506 for transmitting to the primary device 502. In some embodiments, the response may include positioning data 804 and an acknowledgement 806 of the map data 506. The peripheral devices 504 may be configured to transmit the response to the primary device 502 on respective channels and in respective slots. In some embodiments, each peripheral device 504 may be configured to transmit the response on multiple channels. For example, as shown in FIG. 8, the first peripheral device 504(1) may be configured to transmit a first acknowledgement 806(1) and first positioning data 804(1) on a first channel, and the same first acknowledgement 806(1) and first positioning data 804(1) on a second channel. Similarly, the second peripheral device 504(2) may be configured to transmit a second acknowledgement 806(2) and second positioning data 804(2) on a first channel (which may be different from or the same as the first channel on which the first peripheral device 504 transmitted the positioning data and acknowledgement), and the same second acknowledgement 806(2) and second positioning data 804(1) on a second channel. While shown as positioning data 804 and acknowledgements 806 being repeated twice, it is noted that the positioning data 804 and acknowledgements 806 may be repeatedly transmitted any number of times by a respective device and on any number of channels. Transmitting the positioning data and acknowledgements multiple times, and on different channels, may minimize the likelihood of the primary device 502 not receiving such acknowledgements and therefore retransmitting the map data 506 to the peripheral devices 504.

Each of the map data 506, positioning data 804, and acknowledgement(s) 806 may be exchanged between the device over one connection interval (e.g., of 2 ms, or any interval that may be configured in the command described with reference to Table 1). As noted above, the primary device 502 may periodically send map data 506 to the peripheral devices 504. At a first interval (e.g., after the application has first been launched or started on the primary device 502), the primary device 502 may be configured to transmit the full map data 506 to the peripheral devices 504 as is illustrated in FIG. 8. At various subsequent intervals, such as after five minutes, ten minutes, etc., the primary device 502 may be configured to transmit a portion of the map data 506, partial map data 506, an update to the map data 506 previously sent, and so forth. As such, the subsequent map data 506 may have a packet size which is reduced from the packet size of the initial (or full) map data sent at the first interval.

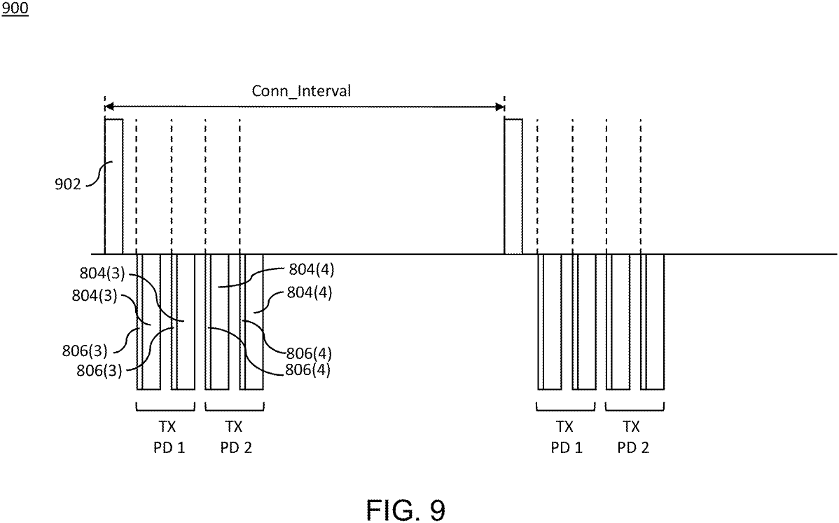

Referring to FIG. 9, in some embodiments, for one or more subsequent intervals, the primary device 502 may be configured to forego transmission of any map data 506 to the peripheral devices 504. Specifically, FIG. 9 is a transmission sequence 900 of the devices 502, 504 shown in the system 500, according to an example implementation of the present disclosure. As shown in FIG. 9, the primary device 502 may be configured to send a poll message 902 to the peripheral devices 504, to poll the peripheral devices 504 for the positioning data 508. The peripheral devices 504 may be configured to respond to the poll message 902 with positioning data 804 and an acknowledgement 806 to the poll message 902 in a manner similar to responding to the map data 506 and poll message as described above.

For the session of the application (e.g., at each connection interval), the primary device 502 and peripheral devices 504 may be configured to periodically send, share, or otherwise exchange poll messages 902, positioning data 804 and acknowledgements 804. At various periodic intervals (e.g., every five minutes, every ten minutes, etc.), the primary device 502 may be configured to communicate partial or updated map data 506 to the peripheral devices 504 (e.g., in a manner similar to the connection sequence 800 shown in FIG. 8). At intervening or intermediate intervals, the primary device 502 may be configured to poll (e.g., without sending map data 506) the peripheral devices 504 for positioning data (e.g., in a manner similar to the connection sequence 900 shown in FIG. 9). As such, for map intervals of the multicast communication session (e.g., intervals in which the primary device 502 communicates map data 506), the connection sequence may follow the connection sequence of FIG. 8. Correspondingly, for non-map intervals of the multicast communication session (e.g., intervals in which the primary device 502 does not communicate map data 506), the connection sequence may follow the connection sequence of FIG. 9. The primary device 502 and peripheral devices 504 may be configured to cycle through the communication intervals through the multicast communication session.

Referring back to FIG. 6, when the primary device 502 determines that the application executing on the primary device 502 has been terminated (e.g., by the user closing the application, selecting a different application, turning off the primary device 502, removing the primary device 502 from their head, etc.), the primary device 502 may be configured to cause the primary device 502 and peripheral devices 504 to exit the multicast mode. The primary device 502 may be configured to generate and send an exit command (e.g., during the multicast communication session) to each of the peripheral devices 504. The primary device 502 may be configured to send the exit command to each of the peripheral devices 504, to cause the peripheral devices 504 to switch from the multicast mode to the ACL connection mode 602. The exit command may include fields similar to those described above with reference to Table 1. For example, the exit command may have a format similar to Table 2 described below.

TABLE 2

Format for Command to Exit Multicast Mode
CtrlData

| | | | | | | | |
|---|---|---|---|---|---|---|---|
| P1_AA | P2_AA | P3_AA | P4_AA | Conn_ Interval | Timeout | Event_ Count | Offset |

The fields in the exit command may include access addresses (AAs) for the first peripheral device 504 through N-th peripheral device 504 (shown as four peripheral devices 504, though any number of peripheral devices 504 may be used in the system 500) [each having four octets], a connection interval (e.g., in multiples of 1.25 ms) [three octets], a timeout (in ms) [two octets], a number of multicast intervals after which the peripheral devices 504 are to switch out of multicast mode [one octet], and an offset time (in microseconds) for the start of the non-multicast mode [two octets]. The primary device 502 may be configured to communicate or transmit the exit command to each of the peripheral devices 504 during the multicast communication session. The peripheral devices 504 may be configured to switch from the multicast mode to a non-multicast mode (e.g., communication via ACL connections) with the primary device 502 according to the exit command.

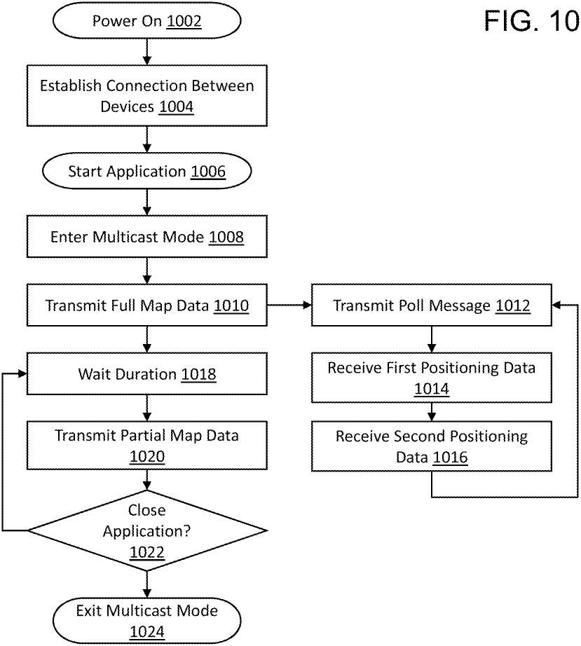

Referring now to FIG. 10, depicted is a flowchart showing an example method 1000 for multicast communication for an augmented reality (AR) or virtual reality (VR) system, such as the system 500 described above. The method 1000 may be performed using the devices, components, or elements described above with reference to FIG. 1 - FIG. 9. As a brief overview, at step 1002, devices may be powered on. At step 1004, a primary device may establish connections with peripheral devices. At step 1006, the primary device may start an application. At step 1008, the primary device and peripheral devices may enter a multicast mode. At step 1010, the primary device may transmit full map data. At step 1012, the primary device may transmit a poll message. At step 1014, the primary device may receive first positioning data. At step 1016, the primary device may receive second positioning data. At step 1018, the primary device may wait a duration. At step 1020, the primary device may transmit partial map data. At step 1022, the primary device may determine whether the application has been closed. At step 1024, the primary device and peripheral devices may exit the multicast mode.

At step 1002, devices may be powered on. The method 1000 may begin when each of a primary device and a number of peripheral devices are turned on, powered on, or otherwise activated (e.g., from a sleep or inactive mode). A user may power on the devices when the user intends to use the devices as part of accessing or otherwise using an AR/VR application provided by the devices. The primary device may be similar to the primary device 502 described above. For example, the primary device may include a head wearable device (HWD), such as the HWD 150 described above with reference to FIG. 1 and FIG. 2. The peripheral devices may be similar to the peripheral devices 504 described above. For example, the peripheral devices may include hand or handheld controllers, similar to the handheld controllers 300 described above with reference to FIG. 3.

At step 1004, a primary device may establish connections between the primary device and the peripheral devices. The primary device may establish a first set of connections between each of the peripheral devices. The primary device may establish a first connection with a first peripheral device and a second connection with a second peripheral device. The first connection and the second connection may be respective asynchronous connection-less (ACL) connections between the devices. The primary device may establish the first and second connections according to a discovery and pairing protocol. The primary device may establish the first and second connections between respective communication devices on the primary device and peripheral devices. The communication devices may be or include BLUETOOTH low-energy (BLE) devices or antennas incorporated into the respective devices.

At step 1006, the primary device may start an application. The primary device may start the application responsive to a user selecting or otherwise causing the primary device to launch the application on the primary device. For example, the primary device may receive a selection (e.g., via one or more user input devices on the primary device and/or a peripheral device) to launch the application. The primary device may launch the application responsive to the selection from the user.

At step 1008, the primary device and peripheral devices may enter a multicast mode. In some embodiments, the primary device may transmit a command to each of the peripheral devices on the respective connections (e.g., established at step 1004) to cause the primary and peripheral devices to switch to, enable, or otherwise enter the multicast mode. The primary device may generate the command to include various information indicative of a start time in which each of the peripheral devices are to switch to the multicast mode. The primary device may determine the start time for each respective peripheral device, based on or according to a number of intervals of the respective connection for the peripheral device and an offset time. The offset time may be or include a difference between the start of an interval for one peripheral device and the start of the nearest corresponding interval for another peripheral device. The primary device may generate and send separate commands to each of the peripheral devices. The peripheral devices and primary device may switch to the multicast mode based on or according to their respective commands from the primary device, such that each of the devices enter the multicast mode at the same time.

At step 1010, the primary device may transmit full map data. In some embodiments, the primary device may transmit a multicast message to the first peripheral device and the second peripheral device. The primary device may transmit the full map data via the multicast message, such that each of the peripheral devices receive the multicast message including the full map data at the same time or substantially the same time. The multicast message may therefore include map data of a virtual environment. The virtual environment may include or correspond to a virtual environment corresponding to the AR/VR application started at step 1006. The primary device may generate the map data responsive to executing the application at step 1006. In some embodiments, the map data may correspond to a physical environment of the primary device. The map data may include absolute positions of various devices / components / features / landmarks of the physical environment. The primary device may generate the map data to include an absolute position of the primary device, such that the peripheral devices may generate positional data according to the map data.

At step 1012, the primary device may transmit a poll message. In some embodiments, the primary device may transmit a poll or poll message to the first peripheral device and the second peripheral device. The primary device may transmit the poll message responsive to completing transmission of the multicast message (e.g., including the full map data at step 1010). The primary device may transmit the poll or poll message at the start of each connection interval of the multicast mode. The primary device may transmit the poll message to each of the peripheral devices, to prompt, request, or otherwise cause the peripheral devices to transmit positioning data to the primary device. As such, the poll message may be or include a poll for positioning data. The primary device may transmit the poll message to each of the peripheral devices via a multicast message.

At step 1014, the primary device may receive first positioning data. In some embodiments, the primary device may receive first positioning data of the first peripheral device with respect to the map data. The primary device may receive the first positioning data responsive to the poll message (e.g., transmitted at step 1012). The first peripheral device may generate the first positioning data based on data from one or more sensors of the peripheral device. The first positioning data may include inertial measurement unit (IMU) data captured via an IMU sensor of the peripheral device. The positioning data may be determined by the first peripheral device according to the map data received by the first peripheral device (e.g., responsive to step 1010). The positioning data may be relative to the absolute positions defined, set, or otherwise provided in the map data.

In some embodiments, the first peripheral device may transmit the first positioning data and an acknowledgement of the poll message and/or map data on a first channel of the multicast mode. The first peripheral device may also transmit the first positioning data and the acknowledgement on a second channel of the multicast mode. In this regard, the first peripheral device may transmit multiple instances of the same data (e.g., the same positioning data and same acknowledgement(s)) on separate channels to the primary device. The primary device may therefore receive the first positioning data and the acknowledgement on the first and second channel from the first peripheral device. In other words, and in some embodiments, the first device may receive a first instance of an acknowledgement of the multicast message and/or poll on the first channel, a first instance of the first positioning data on the first channel, a second instance of the acknowledgement on a second channel, and a second instance of the first positioning data on the second channel. Such implementations may provide for redundancies that reduce the likelihood of the primary device retransmitting the full map data, thus conserving bandwidth and reducing power consumption through retransmissions.

At step 1016, the primary device may receive second positioning data. In some embodiments, the primary device may receive second positioning data of the second peripheral device with respect to the map data. The primary device may receive the second positioning data from the second peripheral device responsive to the poll or poll message transmitted at step 1012. Step 1016 may be similar to step 1014 described above, but originating from the second peripheral device instead of the first peripheral device. As such, and in some embodiments, the second peripheral device may similarly transmit (and the primary device may receive) multiple instances of acknowledgements and the second positioning data on separate channels.

The method 1000 may cycle between step 1012 - step 1016 at each connection interval of the multicast mode or multicast communication session. Thus, at each interval, the primary device may poll the peripheral devices for positioning data (e.g., at step 1012), and the peripheral devices may respond to the poll message from the primary device with respective positioning data (e.g., at steps 1014 and 1016).

At step 1018, the primary device may wait a duration. Step 1018 through step 1024 may be executed in parallel with step 1012 through step 1022. The primary device may wait a defined, predetermined, fixed, or other duration from sending or transmitting the full map data at step 1010. The primary device may wait the duration for transmitting the full map data, to transmit partial, updated, or second map data (e.g., at step 1020). The duration may be defined in terms of a number of communication intervals (e.g., cycles between steps 1012 – 1016). The duration may be or include five minutes, ten minutes, etc. At step 1020, the primary device may transmit partial map data. In some embodiments, the primary device may transmit a second multicast message to the first peripheral device and the second peripheral device at a second time instance which is a defined duration following the first time instance (e.g., in which the device transmitted the full map data 1010). The second multicast message may include second map data of the virtual environment. In some embodiments, the second map data may be or include partial map data. The partial map data may be or include one or more updates to the first map data (e.g., sent at step 1010). The peripheral devices may use the partial map data to update, revise, or otherwise modify the absolute location used to determine the positioning data which is sent (and correspondingly received) at steps 1014 and 1016.

At step 1022, the primary device may determine whether the application has been closed. Step 1022 may serve as an interrupt to the method 1000. As such, while shown as following step 1020, it is noted that step 1022 can be performed at any time following step 1006 (e.g., where the primary device launches or starts the application). The primary device may determine that the application has ended / terminated / closed responsive to a user input to terminate the application, responsive to the user removing the primary device from their head, responsive to the user initiating a shut-down or power-down sequence on the primary device, etc. Where the primary device does not determine that the application has been closed (e.g., the application is still being used / accessed by the user or is otherwise executing on the primary device), the method 1000 may return to step 1018 (and correspondingly, steps 1012 - 1016 in parallel). Where the primary device determines that the application has been closed, the method 1000 may proceed to step 1024.

At step 1024, the primary device and peripheral devices may exit the multicast mode. In some embodiments, the primary device may cause each of the primary device, the first peripheral device, and the second peripheral device to exit the multicast mode responsive to closing of the application. In some embodiments, the primary device may generate and transmit an exit command to the peripheral devices during an interval of the multicast mode responsive to the application being closed. The primary device may generate the exit command to include various data or values indicating a time in which the peripheral devices are to switch to the non-multicast mode. The primary device may generate the exit command to cause the peripheral devices to switch back to connections similar to the connections established at step 1004.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or nonvolatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/-10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method comprising:
transmitting, by a first device, a multicast message to a first peripheral device and a second peripheral device, the multicast message comprising map data of a virtual environment;
transmitting, by the first device, responsive to completing transmission of the multicast message, a poll message to the first peripheral device and the second peripheral device;
receiving, by the first device, from the first peripheral device responsive to the poll message, first positioning data of the first peripheral device with respect to the map data; and
receiving, by the first device, from the second peripheral device responsive to the poll message, second positioning data of the second peripheral device with respect to the map data.

2. The method of claim 1, further comprising:
detecting, by the first device, launch of an application on the first device; and
causing, by the first device, each of the first device, the first peripheral device, and the second peripheral device to enter a multicast mode responsive to launching of the application.

3. The method of claim 2, further comprising:
detecting, by the first device, closing of the application on the first device; and
causing, by the first device, each of the first device, the first peripheral device, and the second peripheral device to exit the multicast mode responsive to closing of the application.

4. The method of claim 2, wherein causing the first peripheral device and the second device to enter the multicast mode comprises:
transmitting, by the first device, a first command to the first peripheral device, the first command indicating a start time for the first peripheral device to enter the multicast mode;
receiving, by the first device, an acknowledgement of the first command from the first peripheral device;
determining, by the first device, an offset for the second peripheral device; and
transmitting, by the first device, a second command to the second peripheral device indicating a start time for the second peripheral device and the offset.

5. The method of claim 1, wherein the first positioning data comprises first inertial measurement unit (IMU) data, wherein receiving the first IMU data comprises:
receiving, by the first device, the first IMU data on a first channel from the first peripheral device; and
receiving, by the first device, the first IMU data on a second channel from the first peripheral device.

6. The method of claim 1, further comprising:
receiving, by the first device, a plurality of instances of an acknowledgement of the map data from the first peripheral device, the acknowledgement being responsive to the multicast message.

7. The method of claim 6, further comprising:
receiving, by the first device, a first instance of the acknowledgement of the map data on a first channel from the first peripheral device;
receiving, by the first device, the first positioning data on the first channel from the first peripheral device;
receiving, by the first device, a second instance of the acknowledgement of the map data on a second channel from the first peripheral device; and
receiving, by the first device, the first positioning data on the second channel from the first peripheral device.

8. The method of claim 1, wherein the multicast message is a first multicast message comprising first map data of the virtual environment, the first multicast message sent at a first time instance, the method further comprising:
transmitting, by the first device at a second time instance which is a defined duration following the first time instance, a second multicast message to the first peripheral device and the second peripheral device, the second multicast message comprising second map data of the virtual environment.

9. The method of claim 8, wherein the second map data comprises one or more updates to the first map data.

10. The method of claim 1, wherein the multicast message and the poll message are transmitted via a first Bluetooth low energy (BLE) device to a second BLE device of the first peripheral device and to a third BLE device of the second peripheral device, wherein the first positioning data is received by the first BLE device via the second BLE device from the first peripheral device, and wherein the second positioning data is received by the first BLE device via the third BLE device from the second peripheral device.

11. The method of claim 1, wherein the first device comprises a head wearable device, the first peripheral device comprises a first handheld controller communicably coupled to the head wearable device, and the second peripheral device comprises a second handheld controller communicably coupled to the head wearable device.

12. A first device comprising:
a communication device configured to:
transmit a multicast message to a first peripheral device and a second peripheral device, the multicast message comprising map data of a virtual environment;
transmit, responsive to completing transmission of the multicast message, a poll message to the first peripheral device and the second peripheral device;
receive, from the first peripheral device responsive to the poll message, first positioning data of the first peripheral device with respect to the map data; and
receive, from the second peripheral device responsive to the poll message, second positioning data of the second peripheral device with respect to the map data.

13. The first device of claim 12, further comprising:
one or more processors configured to:
detect launch of an application on the first device; and
cause each of the first device, the first peripheral device, and the second peripheral device to enter a multicast mode responsive to launching of the application.

14. The first device of claim 13, wherein the one or more processors are further configured to:
detect closing of the application on the first device; and
cause each of the first device, the first peripheral device, and the second peripheral device to exit the multicast mode responsive to closing of the application.

15. The first device of claim 13, wherein to cause the first peripheral device and the second device to enter the multicast mode, the communication device is configured to:
transmit a first command to the first peripheral device, the first command indicating a start time for the first peripheral device to enter the multicast mode;
receive an acknowledgement of the first command from the first peripheral device; and
transmit a second command to the second peripheral device indicating a start time for the second peripheral device and an offset determined for the second peripheral device.

16. The first device of claim 12, wherein the first positioning data comprises first inertial measurement unit (IMU) data, wherein the communication device is configured to:
receive the first IMU data on a first channel from the first peripheral device; and
receive the first IMU data on a second channel from the first peripheral device.

17. The first device of claim 12, wherein the multicast message is a first multicast message comprising first map data of the virtual environment, the first multicast message sent at a first time instance, wherein the communication device is configured to:
transmit, at a second time instance which is a defined duration following the first time instance, a second multicast message to the first peripheral device and the second peripheral device, the second multicast message comprising second map data of the virtual environment.

18. The first device of claim 12, wherein the communication device comprises a first Bluetooth low energy (BLE) device, wherein the multicast message is sent via the first BLE device to a second BLE device of the first peripheral device and to a third BLE device of the second peripheral device, wherein the first positioning data is received via the second BLE device from the first peripheral device, and wherein the second positioning data is received via the third BLE device from the second peripheral device.

19. The first device of claim 12, wherein the first device comprises a head wearable device, the first peripheral device comprises a first handheld controller communicably coupled to the head wearable device, and the second peripheral device comprises a second handheld controller communicably coupled to the head wearable device.

20. A system comprising:
a first peripheral device;
a second peripheral device; and
a primary device communicably coupled to the first peripheral device and the second peripheral device, the primary device configured to:
transmit a multicast message to the first peripheral device and the second peripheral device, the multicast message comprising map data of a virtual environment;
transmit, responsive to completing transmission of the multicast message, a poll message to the first peripheral device and the second peripheral device;
receive, from the first peripheral device responsive to the poll message, first positioning data of the first peripheral device with respect to the map data; and
receive, from the second peripheral device responsive to the poll message, second positioning data of the second peripheral device with respect to the map data.
